(19) United States
(12) Patent Application Publication
(10) Pub. No.: US 2024/0429447 A1
(43) Pub. Date: Dec. 26, 2024

(54) ELECTROLYTE ADDITIVE COMPOSITION, ELECTROLYTE AND SECONDARY BATTERY COMPRISING SAME, AND USE OF SAME

(71) Applicant: MURATA MANUFACTURING CO., LTD., Kyoto (JP)

(72) Inventors: Fan YANG, Shanghai (CN); Cheng ZHU, Shanghai (CN); Kazumasa TAKESHI, Shanghai (CN)

(21) Appl. No.: 18/741,520

(22) Filed: Jun. 12, 2024

(30) Foreign Application Priority Data
Jun. 13, 2023 (CN) 2023106997592

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0025

(57) ABSTRACT

An electrolyte additive composition, an electrolyte and a lithium-ion secondary battery including same, and use of same are provided. The electrolyte additive composition includes a cyano-substituted C₄₋₁₀ aromatic or a heteroaromatic compound; and
a compound represented by the following formula (1)

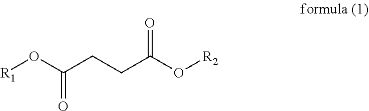

wherein R₁ and R₂ can be the same or different, and are selected from unsubstituted or F-substituted C₁₋₆ alkyl.

### CROSS REFERENCE TO RELATED APPLICATIONS

The present application claims priority to Chinese patent application no. 2023106997592, filed on Jun. 13, 2023, the entire contents of which are incorporated herein by reference.

### BACKGROUND

The present disclosure relates to the field of lithium-ion secondary batteries, and in particular, to an electrolyte additive composition, an electrolyte and a lithium-ion secondary battery comprising same, and the use of same.

In recent years, with the continuous updating of electronic technology, the demand for battery devices used to support the energy supply of electronic equipment has also been increasing. Today, batteries capable of storing more charges and outputting high power are needed. Conventional lead-acid batteries, nickel-hydrogen batteries, and the like have been unable to meet the needs of new electronic products such as mobile devices of smartphones, fixed devices such as electric storage systems, and the like. Therefore, lithium batteries have attracted wide attention. In the development of lithium batteries, the capacity and performance thereof have been improved effectively. A lithium ion battery has advantages such as a high energy density, a high working voltage, a long cycle life, and low environmental pollution, and has become a new green high-energy chemical power supply with great development potential in the world today. Electrolyte is an important component of a lithium ion battery, and has important influences on many properties of the battery, such as voltage, energy density, power, service life, applicable range of temperature, and safety performance. Lithium-ion secondary batteries are research hotspots in the field of new energy in recent years, as they have advantages such as a large energy density, a low self-discharge rate, and small environmental pollution. At present, lithium-ion secondary batteries have been applied to the fields of mobile terminal electronic products and hybrid electric vehicles. With the continuous progress of science and technology, the requirements for performance of lithium ion batteries are getting higher and higher. Issues such as developing a high energy density, broadening the battery operating temperature range, and improving battery safety performance pose severe challenges to the majority of lithium-ion secondary battery researchers. Generally, in a process of charging and discharging a lithium ion battery for the first time, an electrode material reacts with an electrolyte at a solid-liquid phase interface, the electrolyte is reduced and decomposed, and a passivation layer covering the surface of the electrode material is formed. This passivation layer is an interfacial layer that is an insulator for electrons, but is a good conductor for lithium ions. Lithium ions can freely intercalate and deintercalate through the passivation layer. A film formed by the passivation layer covering the electrode contains various inorganic components such as Li₂CO₃, LiF, Li₂O and LiOH, and various organic components such as RO—CO₂Li, ROLi and (ROCO₂Li)₂.

In order to solve the problem that an electrolyte reacts with an electrode material and adversely affects the performance of a lithium-ion secondary battery, an electrolyte additive is generally added, so that a passivation layer is formed on the surface of the electrode material during a first charging and discharging cycle of the battery, thereby protecting the battery material from being corroded by the electrolyte. The main action mechanism of an additive used in the prior art is that the additive reacts directly on the surface of the electrode, and the reaction product adheres to the surface of the electrode to form a stable SEI or CEI passivation layer on the surface of the electrode, so as to improve the service life of the battery. However, electrolyte additives used in the prior art cannot effectively protect electrodes, so that batteries show poor high-temperature resistance and a poor capacity retention rate. Therefore, in order to solve the described problems, there is still a need to develop an electrolyte additive capable of effectively forming an electrode protection film and ensuring the electric performance of a lithium-ion secondary battery.

### SUMMARY

The present disclosure, in an embodiment, relates to providing an electrolyte additive composition, an electrolyte and a lithium-ion secondary battery comprising same, and the use of same, so as to solve the problem that a battery exhibits poor high-temperature resistance and a poor capacity retention rate at a high temperature. According to an embodiment of the present disclosure, an electrolyte additive composition is provided and includes a compound represented by formula (1) and a cyano-substituted C₄₋₁₀ aromatic compound or heteroaromatic compound:

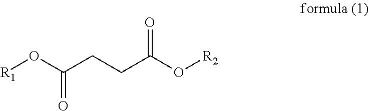

wherein R₁ and R₂ can be the same or different and are each independently selected from unsubstituted or F-substituted C₁₋₆ alkyl.

Further, in the electrolyte additive composition, R₁ and R₂ are each independently selected from unsubstituted or F-substituted C₁₋₃ alkyl according to an embodiment.

Further, in the electrolyte additive composition, in an embodiment, the cyano-substituted C₄₋₁₀ aromatic compound or heteroaromatic compound is further substituted by a substituent selected from the group consisting of:
unsubstituted or F-substituted C₁₋₆ alkyl,

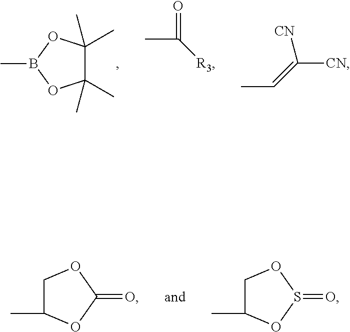

wherein R₃ is selected from C₁₋₆ alkyl.

Further, in the electrolyte additive composition, in an embodiment, the C₄₋₁₀ aromatic or heteroaromatic compound is selected from benzene, naphthalene, furan, thiophene, pyrrole, pyrazole, imidazole, oxazole, thiazole, pyridine, benzofuran, benzothiophene, indole, benzimidazole, benzoxazole, benzothiazole, and quinoline.

Further, in the electrolyte additive composition, in an embodiment, the compound of formula (1) is any one selected from:

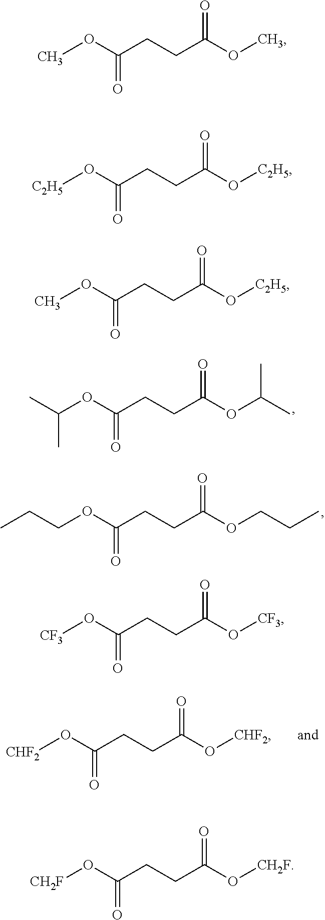

Further, in the electrolyte additive composition, in an embodiment, the cyano-substituted C₄₋₁₀ aromatic compound or heteroaromatic compound is any one of:

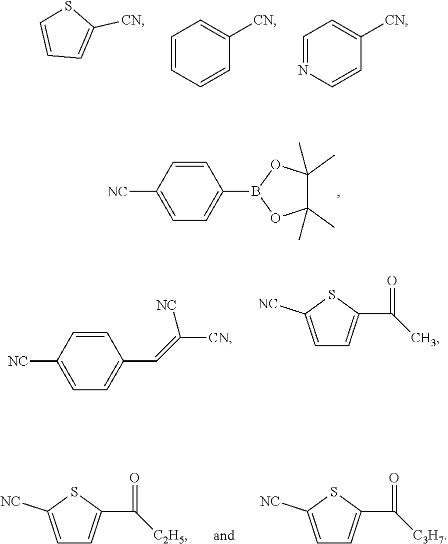

Further, in the electrolyte additive composition, in an embodiment, the molar ratio of the compound of formula (1) to the cyano-substituted C₄₋₁₀ aromatic or heteroaromatic compound is in the range of 1:2 to 7:2.

According to another embodiment of the present disclosure, an electrolyte is provided and includes an organic solvent, a lithium salt, and the electrolyte additive composition of any one of claims 1 to 7.

Further, in the electrolyte, in an embodiment, the amount of the compound represented by formula (1) is in the range of about 0.1 parts by weight to about 10 parts by weight; preferably, the amount of the compound represented by formula (1) is in the range of about 0.1 parts by weight to about 2.0 parts by weight; and more preferably, the amount of the compound represented by formula (1) is in the range of about 0.2 parts by weight to about 1.0 part by weight, based on 100 parts by weight of the total weight of the organic solvent and the lithium salt.

Further, in the electrolyte, in an embodiment, the amount of the cyano-substituted C₄₋₁₀ aromatic compound or heteroaromatic compound is in the range of about 0.1 parts by weight to about 10 parts by weight; preferably, the amount of the cyano-substituted C₄₋₁₀ aromatic compound or heteroaromatic compound is in the range of about 0.1 parts by weight to about 2.0 parts by weight; and more preferably, the amount of the cyano-substituted C₄₋₁₀ aromatic compound or heteroaromatic compound is in the range of about 0.2 parts by weight to about 1.0 part by weight, based on 100 parts by weight of the total weight of the organic solvent and the lithium salt.

Further, in the electrolyte, in an embodiment, the lithium salt is selected from the group consisting of LiPF₆, LiBF₄, LiAsF₆, LiCF₃SO₃, LiN(SO₂F)₂, LiN(SO₂CF₃)₂, LiC(SO₂CF₃)₃, Li₂SiF₆, or any combination thereof.

Further, in the electrolyte, in an embodiment, the organic solvent is selected from the group consisting of propylene carbonate, butylene carbonate, fluoroethylene carbonate, diethyl carbonate, dipropyl carbonate, methylethyl carbonate, ethylene carbonate, dimethyl carbonate, or any combination thereof.

According to yet another embodiment of the present disclosure, a lithium-ion secondary battery is provided and includes a positive electrode sheet, a negative electrode sheet, a separator, and the electrolyte of the present disclosure.

According to still yet another embodiment of the present disclosure, the use of the electrolyte additive composition of the present disclosure is provided for preparing one or both of an electrolyte for a lithium-ion secondary battery and a lithium-ion secondary battery.

By means of the electrolyte additive composition, the electrolyte and the lithium-ion secondary battery comprising same, and the use of same of the present disclosure, the technical effects of reducing the internal resistance of the lithium-ion secondary battery, and improving the capacity retention rate and electric properties at high temperatures of the lithium-ion secondary battery after cycling are achieved according to an embodiment.

### DETAILED DESCRIPTION

The present disclosure is described below in further detail according to an embodiment. It is important to note that the examples of the present disclosure and the characteristics in the examples can be combined in any suitable manner. Hereinafter, the present disclosure will be described in further detail including with reference to the examples according to an embodiment. The following examples are merely exemplary, and do not limit the scope of protection of the present disclosure.

In the present disclosure, “aromatic compound” refers to an aromatic hydrocarbon compound containing a specific number of carbon atoms, such as benzene, naphthalene, anthracene, or phenanthrene. The prefix “hetero” refers to a compound or group that comprises at least one heteroatom (e.g., 1, 2, or 3 heteroatoms) as a ring member, where each heteroatom is independently, for example, N, O, or S.

As explained in the background, electrolyte additives cannot effectively form an interfacial film on an electrode surface, and enable a lithium-ion secondary battery to exhibit excellent high-temperature resistance and an excellent capacity retention rate. To address such problems, the present disclosure provides, in an embodiment, an electrolyte additive composition including a compound represented by the following formula (1) and a cyano-substituted C₄₋₁₀ aromatic or heteroaromatic compound:

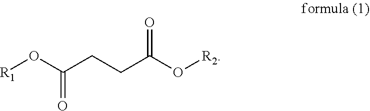

In formula (1), R₁ and R₂ can be the same or different and are each independently selected from unsubstituted or F-substituted C₁₋₆ alkyl.

Based on experimentation in relation to the present disclosure, it was surprisingly found that when the compound as shown in formula (1) and the cyano-substituted C₄₋₁₀ aromatic compound or heteroaromatic compound are simultaneously added to the electrolyte, after the first charging/discharging, the two materials above can react on the surfaces of the negative electrode and the positive electrode, thereby forming a heteropolycyclic structure. During the first charging/discharging cycle, the surface of the negative electrode is in an electron-deficient state, and thus it is locally strongly alkaline. The compound represented by formula (1) of the present disclosure and the cyano-substituted C₄₋₁₀ aromatic compound or heteroaromatic compound can react on the surface of the negative electrode and condense to form a heteropolycyclic compound (such as, but not limited to, pyrrolopyrrole). The formed heteropolycyclic compound has a planar structure, so that the heteropolycyclic compound can be attached to the surface of the negative electrode, thereby forming an interfacial film (SEI film) coated on the surface of the negative electrode. In other embodiments, after the heteropolycyclic compound is formed, the heteropolycyclic compound can be further polymerized to form a dimer, a trimer, or a polymer, thereby forming a dense interfacial film (SEI film) coated on the surface of the negative electrode. Furthermore, as the polycyclic conjugate structure has a small HOMO-LUMO energy gap, a reaction can also be performed on the positive electrode after the molecules are formed, so that an interfacial film (CE1 film) coated on the surface of the negative electrode can be generated. The formed interfacial film can effectively and completely cover the positive electrode and the negative electrode, thereby avoiding direct contact between the positive electrode material and the negative electrode material and the electrolyte, and suppressing decomposition and deterioration of the positive electrode material and the negative electrode material. In addition, the formed interfacial film has a primary structure of, for example, pyrrolopyrrole (no dimerization or polymerization occurs), so that a plurality of heteroatom sites in the structure thereof can increase the electric conductivity of the interfacial film, thereby reducing the internal resistance of the lithium-ion secondary battery formed thereby.

In an embodiment, the compound of formula (1) of the present disclosure is:

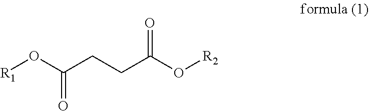

wherein R₁ and R₂ can be the same or different and are each independently selected from unsubstituted or F-substituted C₁₋₃ alkyl.

In an embodiment, the compound of formula (1) of the present disclosure can be any one selected from:

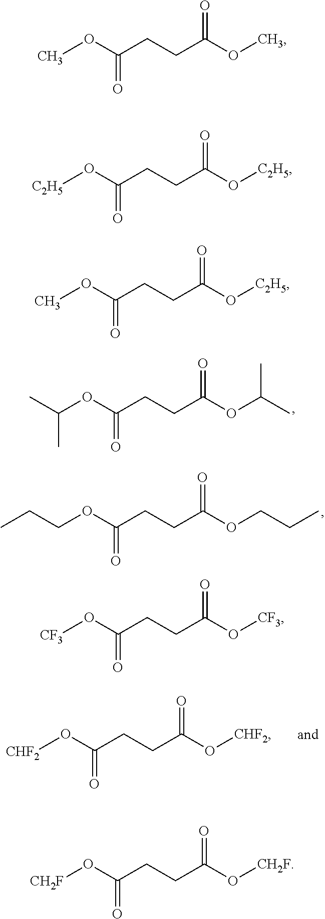

In an embodiment of the present disclosure, the cyano-substituted C₄₋₁₀ aromatic compound or heteroaromatic compound comprised in the electrolyte additive composition can be substituted with additional substituents. The additional substituents, for example, are selected from the group consisting of:
unsubstituted or F-substituted C₁₋₆ alkyl

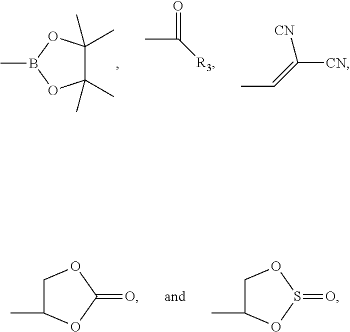

wherein R₃ is selected from C₁₋₆ alkyl. In some specific embodiments, the F-substituted C₁₋₆ alkyl is F-substituted C₁₋₃ alkyl, and preferably CF₃, C₂F₅, or C₃F₇.

Furthermore, in a preferred embodiment, the backbone (main chain) of the cyano-substituted C₄₋₁₀ aromatic compound or heteroaromatic compound comprised in the electrolyte additive composition is selected from benzene, naphthalene, furan, thiophene, pyrrole, pyrazole, imidazole, oxazole, thiazole, pyridine, benzofuran, benzothiophene, indole, benzimidazole, benzoxazole, benzothiazole, and quinoline. Preferably, the backbone (main chain) of the C₄₋₁₀ aromatic compound or heteroaromatic compound is benzene, thiophene, or pyridine.

In an embodiment, the molar ratio of the compound of formula (1) to the cyano-substituted C₄₋₁₀ aromatic compound or heteroaromatic compound is in the range of 1:2 to 7:2. In a preferred embodiment, the molar ratio of the compound of formula (1) to the cyano-substituted C₄₋₁₀ aromatic compound or heteroaromatic compound is in the range of 2:2 to 4:2. When the molar ratio of the compound of formula (1) to the cyano-substituted C₄₋₁₀ aromatic compound or heteroaromatic compound is less than 1:2, the amount of the compound of formula (1) is too small, and therefore a planar structure having multiple heterocycles cannot be effectively formed. When the molar ratio of the compound of formula (1) to the cyano-substituted C₄₋₁₀ aromatic compound or heteroaromatic compound is more than 7:2, the amount of the cyano-substituted C₄₋₁₀ aromatic compound or heteroaromatic compound is too large, a complex non-planar structure of a polymer can be formed, and after coating on the surfaces of the positive electrode and the negative electrode, the resistance of a lithium-ion secondary battery is disadvantageously increased.

In an embodiment, the molar ratio of the compound of formula (1) to the cyano-substituted C₄₋₁₀ aromatic compound or heteroaromatic compound can be in the range of 1:2 to 7:2, 2:2 to 7:2, 3:2 to 7:2, 4:2 to 7:2, 5:2 to 7:2, 6:2 to 7:2, 1:2 to 6:2, 1:2 to 5:2, 1:2 to 4:2, or 1:2 to 3:2.

In another embodiment of the present disclosure an electrolyte is provided and includes an organic solvent, a lithium salt, and the electrolyte additive composition described herein. Due to the inclusion of the electrolyte additive of the present disclosure, the electrolyte of the present disclosure can form a heteropolycyclic compound having a planar structure on the surfaces of the positive electrode and the negative electrode during the first cycle of the battery. As a result, the heteropolycyclic compound having a planar structure can adhere to the surfaces of the positive electrode and the negative electrode, an interfacial film coated on the surfaces of the positive electrode and the negative electrode can be formed. When the electrolyte of the present disclosure is used, the electric conductivity of the interfacial film can be effectively increased, the internal resistance of the lithium-ion secondary battery thus formed can be reduced, and the cycle retention rate can be increased.

In an embodiment of the present disclosure, in the electrolyte of the present disclosure, the amount of the compound represented by formula (1) is in the range of about 0.1 parts by weight to about 10 parts by weight; preferably, the amount of the compound represented by formula (1) is in the range of about 0.1 parts by weight to about 2.0 parts by weight; and more preferably, the amount of the compound represented by formula (1) is in the range of about 0.2 parts by weight to about 1.0 part by weight, based on 100 parts by weight of the total weight of the organic solvent and the lithium salt. In an embodiment, depending on the various combinations of the lithium salt, the organic solvent, and the cyano-substituted C₄₋₁₀ aromatic compound or heteroaromatic compound, the amount of the compound represented by formula (1) present in the electrolyte can be in the range of about 0.1 parts by weight to about 10 parts by weight, in the range of about 0.2 parts by weight to about 10 parts by weight, in the range of about 0.3 parts by weight to about 10 parts by weight, in the range of about 0.4 parts by weight to about 10 parts by weight, in the range of about 0.5 parts by weight to about 10 parts by weight, in the range of about 0.6 parts by weight to about 10 parts by weight, in the range of about 0.7 parts by weight to about 10 parts by weight, in the range of about 0.8 parts by weight to about 10 parts by weight, in the range of about 0.9 parts by weight to about 10 parts by weight, in the range of about 1 part by weight to about 10 parts by weight, in the range of about 2 parts by weight to about 10 parts by weight, in the range of about 3 parts by weight to about 10 parts by weight, in the range of about 4 parts by weight to about 10 parts by weight, in the range of about 5 parts by weight to about 10 parts by weight, in the range of about 0.1 parts by weight to about 9 parts by weight, in the range of about 0.1 parts by weight to about 8 parts by weight, in the range of about 0.1 parts by weight to about 7 parts by weight, in the range of about 0.1 parts by weight to about 6 parts by weight, in the range of about 0.1 parts by weight to about 5 parts by weight, in the range of about 0.1 parts by weight to about 4 parts by weight, in the range of about 0.1 parts by weight to about 3 parts by weight, in the range of about 0.1 parts by weight to about 2 parts by weight, in the range of about 0.1 parts by weight to about 1 part by weight, in the range of about 0.2 parts by weight to about 1 part by weight, in the range of about 0.3 parts by weight to about 1 part by weight, in the range of about 0.4 parts by weight to about 1 part by weight, in the range of about 0.5 parts by weight to about 1 part by weight, in the range of about 0.6 parts by weight to about 1 part by weight, in the range of about 0.7 parts by weight to about 1 part by weight, in the range of about 0.8 parts by weight to about 1 part by weight, or in the range of about 0.9 parts by weight to about 1 part by weight.

In an embodiment of the present disclosure, the amount of the cyano-substituted C₄₋₁₀ aromatic compound or heteroaromatic compound is in the range of about 0.1 parts by weight to about 10 parts by weight; preferably, the amount of the cyano-substituted C₄₋₁₀ aromatic compound or heteroaromatic compound is in the range of about 0.1 parts by weight to about 2.0 parts by weight; and more preferably, the amount of the cyano-substituted C₄₋₁₀ aromatic compound or heteroaromatic compound is in the range of about 0.2 parts by weight to about 1.0 part by weight, based on 100 parts by weight of the total weight of the organic solvent and the lithium salt. In another embodiment of the present disclosure, depending on different combinations of the lithium salt, the organic solvent, and the compound represented by formula (1), the amount of the cyano-substituted C₄₋₁₀ aromatic compound or heteroaromatic compound present in the electrolyte can be in the range of about 0.1 parts by weight to about 10 parts by weight, in the range of about 0.2 parts by weight to about 10 parts by weight, in the range of about 0.3 parts by weight to about 10 parts by weight, in the range of about 0.4 parts by weight to about 10 parts by weight, in the range of about 0.5 parts by weight to about 10 parts by weight, in the range of about 0.6 parts by weight to about 10 parts by weight, in the range of about 0.7 parts by weight to about 10 parts by weight, in the range of about 0.8 parts by weight to about 10 parts by weight, in the range of about 0.9 parts by weight to about 10 parts by weight, in the range of about 1 part by weight to about 10 parts by weight, in the range of about 2 parts by weight to about 10 parts by weight, in the range of about 3 parts by weight to about 10 parts by weight, in the range of about 4 parts by weight to about 10 parts by weight, in the range of about 5 parts by weight, in the range of about 0.1 parts by weight to about 9 parts by weight, in the range of about 0.1 parts by weight to about 8 parts by weight, in the range of about 0.1 parts by weight to about 7 parts by weight, in the range of about 0.1 parts by weight to about 6 parts by weight, in the range of about 0.1 parts by weight to about 5 parts by weight, in the range of about 0.1 parts by weight to about 4 parts by weight, in the range of about 0.1 parts by weight to about 3 parts by weight, in the range of about 0.1 parts by weight to about 2 parts by weight, in the range of about 0.1 part by weight to about 1 part by weight, in the range of about 0.2 parts by weight to about 1 part by weight, in the range of about 0.3 parts by weight to about 1 part by weight, in the range of about 0.4 parts by weight to about 1 part by weight, in the range of about 0.5 parts by weight to about 1 part by weight, in the range of about 0.6 parts by weight to about 1 part by weight, in the range of about 0.7 parts by weight to about 1 part by weight, in the range of about 0.8 parts by weight to about 1 part by weight, or in the range of about 0.9 parts by weight to about 1 part by weight.

The present disclosure has no particular limitation on the components of the lithium salt contained in the electrolyte Examples of the lithium salt include, but are not limited to, LiCl, LiBr, LiPF₆, LiBF₄, LiAsF₆, LiCIO₄, LiB(C₆H₅)₄, LiCH₃SO₃, LiCF₃SO₃, LiN(SO₂F)₂, LiN(SO₂CF₃)₂, LiC(SO₂CF₃)₃, LiAlCl₄, and any combination thereof.

In the present disclosure, the organic solvent of the nonaqueous electrolyte can be any nonaqueous solvent heretofore used for nonaqueous electrolytes. Examples include, but are not limited to, linear or cyclic carbonates, such as ethylene carbonate, propylene carbonate, butylene carbonate, diethyl carbonate, dimethyl carbonate, methyl ethyl carbonate, dipropyl carbonate, and fluoroethylene carbonate; ethers, such as 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, and diethyl ether; sulfones, such as sulfolane and methylsulfolane; nitriles, such as acetonitrile, propionitrile, and acrylonitrile; esters, such as acetates, propionates, and butyrates. These non-aqueous solvents can be used alone or a plurality of solvents can be used in combination. In an embodiment, the electrolyte comprises ethylene carbonate, propylene carbonate, butylene carbonate, fluoroethylene carbonate, diethyl carbonate, dipropyl carbonate, methylethyl carbonate, ethylene carbonate and/or dimethyl carbonate, and any combination thereof. In a preferred embodiment, at least one carbonate is used as the organic solvent of the electrolyte. In other preferred embodiments, the described nonaqueous solvents can be used in any combination to form an electrolyte complying with specific requirements.

In another embodiment of the present disclosure, provided is a lithium-ion secondary battery, comprising a positive electrode sheet, a negative electrode sheet, a separator, and the electrolyte. The lithium-ion secondary battery includes the electrolyte, and thus has reduced internal resistance and an increased cycle retention rate according to an embodiment.

The positive electrode sheet of the present disclosure comprises a positive electrode current collector and a positive electrode active material layer containing a positive electrode active material. A positive electrode active material layer is formed on both surfaces of the positive electrode collector. As the positive electrode current collector, a metal foil such as an aluminum foil, a nickel foil, and a stainless steel foil can be used.

The positive electrode active material layer contains, as the positive electrode active material, one or two or more of positive electrode materials capable of absorbing and releasing lithium ions, and may contain, as necessary, another material such as a positive electrode binder and/or a positive electrode conductive agent.

Preferably, the positive electrode material is a lithium-containing compound. Examples of such lithium-containing compound include lithium-transition metal composite oxides, lithium-transition metal phosphate compounds, and the like. The lithium-transition metal composite oxides are oxides containing Li and one or two or more transition metal elements as constituent elements, and the lithium-transition metal phosphate compounds are phosphate compounds containing Li and one or two or more transition metal elements as constituent elements. Among them, the transition metal element is favorably any one or two or more of Co, Ni, Mn, Fe, etc.

Examples of the lithium-transition metal composite oxides include, for example, LiCoO₂, LiNiO₂, and the like. Examples of lithium-transition metal phosphate compounds include, for example, LiFePO₄, LiFe₁₋ᵤMnᵤPO₄ (0<u<1), and the like.

In an embodiment of the present application, the positive electrode material can be a ternary positive electrode material such as nickel cobalt lithium aluminate (NCA) or nickel cobalt lithium manganate (NCM). Specific examples can include NCA, LixNiyCozAl1-y-zO₂ (1≤x≤1.2, 0.5≤y≤1, and 0≤z≤0.5) and NCM, LiNixCoyMnzO₂ (x+y+z=1, 0<x<1, 0<y<1, 0<z<1). Specific examples of the positive electrode material may include without limitation: LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.75}Ni_{0.1}O₂ and Li_{1.15}(Mn_{0.65}Ni_{0.22}Co_{0.13})O₂, LiFePO₄, LiMnPO₄, LiFe_{0.5}Mn_{0.5}PO₄ and LiFe_{0.3}Mn_{0.7}PO₄.

Further, the positive electrode material can be, for example, any one or two or more of oxides, disulfides, chalcogenides, conductive polymers, etc. Examples of the oxides include, for example, titanium oxide, vanadium oxide, manganese dioxide, etc. Examples of the disulfides include, for example, titanium disulfide, molybdenum sulfide, etc. Examples of the chalcogenides include niobium selenide, etc. Examples of the conductive polymer include, for example, sulfur, polyaniline, polythiophene, etc. However, the positive electrode material can be a material different from those described above.

Examples of the positive electrode conductive agent include carbon materials such as graphite, carbon black, acetylene black, and Ketjen black. These can be used alone, or two or more thereof can be used in mixture. It should be noted that the positive electrode conductive agent can be a metal material, a conductive polymer, or the like as long as it has electric conductivity.

Examples of the positive electrode binder include, for example, synthetic rubbers, which can be, for example, styrene butadiene rubber, fluorine rubber, and ethylene propylene diene, and polymer materials, which can be, for example, polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, lithium polyacrylate, ethylene-propylene-diene terpolymer (EPDM), sulfonated EPDM, and polyimides. These can be used alone, or two or more thereof can be used in mixture.

The negative electrode sheet, in an embodiment, comprises a negative electrode current collector and a negative electrode active material layer containing a negative electrode active material. The negative electrode active material layer is formed on both surfaces of the negative electrode current collector. As the negative electrode current collector, a metal foil such as a copper (Cu) foil, a nickel foil, and a stainless steel foil can be used.

The negative electrode active material layer contains, as a negative electrode active material, a material capable of absorbing and releasing lithium ions, and may contain, as necessary, another material such as a negative electrode binder and/or a negative electrode conductive agent. Details of the negative electrode binder and the negative electrode conductive agent are the same as those of the positive electrode binder and the positive electrode conductive agent, for example.

The active material of the negative electrode is any one or a combination of more of lithium metal, lithium alloys, carbon materials, silicon or tin, and oxides thereof.

As a carbon material has a low potential when absorbing lithium ions, a high energy density can be obtained, and the battery capacity can be increased. In addition, the carbon material also functions as a conductive agent. Such carbon materials is, for example, natural graphite, artificial graphite, a material obtained by coating them with amorphous carbon, or the like. It should be noted that the shape of the carbon material is fibrous, spherical, granular, scale-like, or the like. The silicon-based material includes nano silicon, silicon alloys, and silicon-carbon composite materials formed by compounding SiO, and graphite. Preferably, SiO_{w} is silicon monoxide, silicon dioxide, or other silicon-based material.

The negative electrode material can be, for example, one or two or more of easily graphitizable carbon, hardly graphitizable carbon, metal oxide, polymer compounds, and the like. Examples of the metal oxide include, for example, iron oxide, ruthenium oxide, molybdenum oxide, and the like. Examples of the polymer compound include, for example, polyacetylene, polyaniline, polypyrrole, and the like. However, the negative electrode material can be another material different from those describedherein.

The separator of the present disclosure serves to separate the positive electrode sheet and the negative electrode sheet in the battery, allow ions to pass therethrough, and prevent current short-circuiting due to contact between the two electrode sheet. The separator is, for example, a porous film formed of a synthetic resin, ceramic, or the like, and can be a laminated film in which two or more porous films are laminated. Examples of the synthetic resin include, for example, polytetrafluoroethylene, polypropylene, polyethylene, cellulose, and the like.

In an embodiment, when charge is performed, for example, lithium ions are released from the positive electrode and are absorbed in the negative electrode through the nonaqueous electrolyte impregnated in the separator. When discharge is performed, for example, lithium ions are released from the negative electrode and are absorbed in the positive electrode through the nonaqueous electrolyte impregnated in the separator.

In another I embodiment of the present disclosure, provided is the use of the electrolyte additive of the present application for preparing a lithium-ion secondary battery. After the electrolyte additive composition of the present application is added to a lithium-ion secondary battery, the electrolyte additive composition will react during the first charging/discharging cycle, and the reaction product will cover the surface of the positive electrode and the negative electrode, thereby reducing the internal resistance of the battery and increasing the cycle retention rate.

The present disclosure will be described in further detail including with reference to the following examples according to an embodiment.

### Examples of Nickel Cobalt Lithium Aluminate Batteries

### Preparation of Electrolyte

### Example 1

### Preparation of Negative Electrode

Under conditions of vacuum and completely dry, 97.0 g of graphite powder, 2.0 g of styrene-butadiene rubber, and 1.0 g of carboxymethyl cellulose were weighed at a temperature of 20° C., added into water, and stirred until uniform to obtain a negative electrode active material slurry. The negative electrode active material slurry was coated on a copper foil to obtain a negative electrode current collector, the negative electrode current collector was dried, and a negative electrode sheet was formed using a stamping forming process.

### Preparation of Positive Electrode

Under conditions of vacuum and completely dry, 92.0 g of lithium nickel cobalt aluminate as a positive electrode active material, 5.0 g of conductive carbon black, and 3.0 g of polyvinylidene fluoride were mixed at a temperature of 20° C. to obtain a positive electrode mixture, and the obtained positive electrode mixture was dispersed in N-methylpyrrolidone to obtain a positive electrode mixture slurry. Subsequently, the positive electrode mixture slurry was coated onto an aluminum foil to obtain a positive electrode current collector, the positive electrode current collector was dried, and a positive electrode sheet was formed using a stamping forming process.

### Preparation of Electrolyte

20.0 g of ethylene carbonate, 62.0 g of dimethyl carbonate, and 18.0 g of lithium hexafluorophosphate were mixed to prepare a basic electrolyte. 0.5 g of compound 1 of the following formula and 0.5 g of compound 2 of the following formula were added to the basic electrolyte to obtain an electrolyte for the battery, wherein the compound 1 is

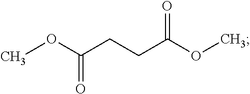

and the compound 2 is

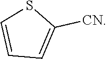

### Assembly of Battery

A CR2016 button cell was assembled in a dry laboratory. The positive electrode sheet prepared in the described step is used as a positive electrode, and the negative electrode sheet prepared in the described step is used as a negative electrode. The positive electrode, the negative electrode, the separator, and a battery housing for the button cell were assembled, and the electrolyte was injected. The positive electrode, the negative electrode, the separator, and a battery housing for the button cell were assembled. After the battery was assembled, the battery was allowed to stand for about 24 h aging, so as to obtain a nickel cobalt lithium aluminate button battery.

### Examples 2-14

Button batteries of Examples 2-14 were prepared according to the same method as that of Example 1, the differences are shown in the following table:

TABLE 1

| | | Addition | | Addition |
|---|---|---|---|---|
| | | amount of | | amount of |
| | First | first | Second | second |
| Example | additive | additive (g) | additive | additive (g) |
| 1 | Compound | 0.5 | Compound 2 | 0.5 |
| | 1 | | | |
| 2 | Compound | 0.5 | Compound 7 | 0.5 |
| | 1 | | | |
| 3 | Compound | 0.5 | Compound 2 | 0.2 |
| | 1 | | | |
| 4 | Compound | 0.5 | Compound 3 | 0.5 |
| | 1 | | | |
| 5 | Compound | 0.5 | Compound 5 | 0.5 |
| | 1 | | | |
| 6 | Compound | 0.2 | Compound 2 | 0.5 |
| | 1 | | | |
| 7 | Compound | 0.5 | Compound 2 | 0.8 |
| | 1 | | | |
| 8 | Compound | 0.5 | Compound 4 | 0.5 |
| | 1 | | | |
| 9 | Compound | 0.5 | Compound 6 | 0.5 |
| | 1 | | | |
| 10 | Compound | 0.8 | Compound 2 | 0.2 |
| | 1 | | | |
| 11 | Compound | 0.8 | Compound 2 | 0.5 |
| | 1 | | | |
| 12 | Compound | 0.8 | Compound 2 | 0.8 |
| | 1 | | | |
| 13 | Compound | 0.2 | Compound 2 | 0.2 |
| | 1 | | | |
| 14 | Compound | 0.5 | Compound 2 | 1.0 |
| | 1 | | | |
| 15 | Compound | 1.0 | Compound 2 | 1.0 |
| | 1 | | | |

Among these, compounds 3-7 used in Examples 2-14 are shown below.

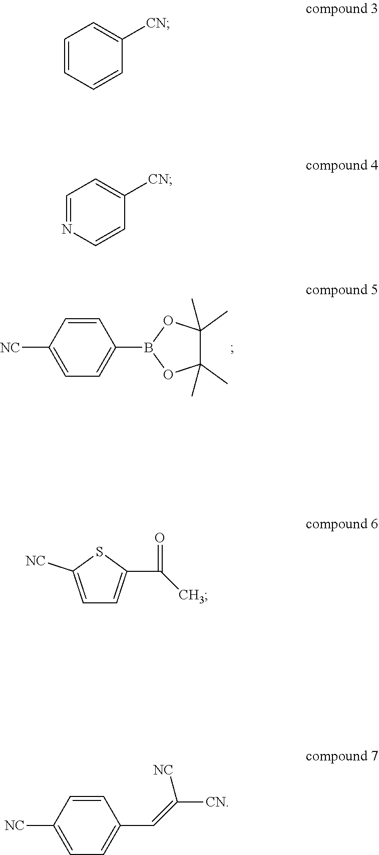 [SMILES: N#Cc1ccccc1 ; N#Cc1ccncc1 ; CC1(C)OB(c2ccc(C#N)cc2)OC1(C)C ; CC(=O)c1ccc(C#N)s1 ; N#CC(C#N)=Cc1ccc(C#N)cc1]

### Comparative Example 1

A button battery of Comparative Example 1 was prepared according to the same method as that of Example 1, except that no electrolyte additive was added after the basic electrolyte was prepared.

### Testing of Battery Performance

### Determination of Capacity Retention Rate

The capacity retention rate of the lithium-ion secondary batteries produced by each of the described examples and each of the comparative examples was measured as follows. First, charging was performed under conditions of room temperature, a charge voltage of 4.25 V, a charge current of 0.5 mA, and a charge time of 10 hours, then discharging was performed under conditions of a discharge current of 0.5 mA and a terminal voltage of 2.0 V, and an initial discharge capacity was measured. Next, repeating charging and discharging were performed under charge conditions of an ambient temperature of 60° C., a charge voltage of 4.25 V, a charge current of 5 mA and a charge time of 1 hour, and discharge conditions of a discharge current of 25 mA and a terminal voltage of 2.5 V. The discharge capacity at the first cycle and the discharge capacity at the 100th cycle were measured. Next, the capacity retention rate (%) after 100 cycles was calculated based on the following formula using the discharge capacity at the first cycle and the discharge capacity at the 100th cycle.

$$Capacity retention rate after 100 cycles [ \% ] =$$

$$( discharge capacity at the 100 th cycle /$$

$$discharge capacity at the first cycle ) \times 100 \%$$

### Determination of Impedance

The lithium-ion secondary batteries were kept at room temperature, and charged once at 0.5 C, and then the initial impedance value of the batteries was determined. 100 charge-discharge cycles were carried out at a temperature of 60° C., and the final impedance value of the battery was measured at the end. The impedance growth of the battery was calculated by the following formula.

Impedance growth rate=final impedance value/initial impedance value

The experimental results are shown in Table 2 below.

TABLE 2

| | Impedance | Capacity |
|---|---|---|
| | growth rate | retention rate |
| | after cycling | after cycling |
| Example 1 | 60% | 84% |
| Example 2 | 60% | 84% |
| Example 3 | 62% | 84% |
| Example 4 | 63% | 84% |
| Example 5 | 65% | 81% |
| Example 6 | 65% | 83% |
| Example 7 | 74% | 84% |
| Example 8 | 75% | 80% |
| Example 9 | 75% | 84% |
| Example 10 | 76% | 82% |
| Example 11 | 78% | 84% |
| Example 12 | 80% | 83% |
| Example 13 | 81% | 78% |
| Example 14 | 96% | 78% |
| Example 15 | 136% | 83% |
| Comparative | 283% | 77% |
| Example 1 | | |

From the description above, it can be determined that the examples of the present disclosure achieve the following technical effects according to an embodiment.

It can be determined from the contents of Table 2 that, in the case of using the electrolyte additive composition of the present disclosure, the impedance of the lithium-ion secondary battery after cycling is significantly reduced as compared with Comparative Example 1 (without using the electrolyte additive). The battery performance tests were all carried out at a high temperature of 60° C., and thus the electrolyte additive composition of the present disclosure can enable a lithium-ion secondary battery to also exhibit excellent electric properties at a high temperature. As compared with Comparative Example 1, Examples 1 to 3 of the present disclosure exhibited the best impedance decrease, and the impedance growth rate was decreased from 283% to 60%. Examples 1-4, 7, and 11 of the present disclosure exhibited an optimal capacity retention rate after cycling as compared with Comparative Example 1.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrolyte additive composition comprising:
a cyano-substituted C₄₋₁₀ aromatic compound or a heteroaromatic compound; and
a compound represented by formula (1) 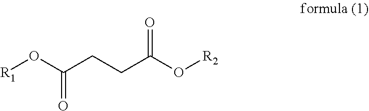
wherein R₁ and R₂ are same or different and selected from unsubstituted or F-substituted C₁₋₆ alkyl.

2. The electrolyte additive composition of claim 1, wherein R₁ and R₂ are selected from unsubstituted or F-substituted C₁₋₃ alkyl.

3. The electrolyte additive composition of claim 1, wherein the cyano-substituted C₄₋₁₀ aromatic compound or the heteroaromatic compound is further substituted by a substituent selected from the group consisting of:
unsubstituted or F-substituted C₁₋₆ alkyl, 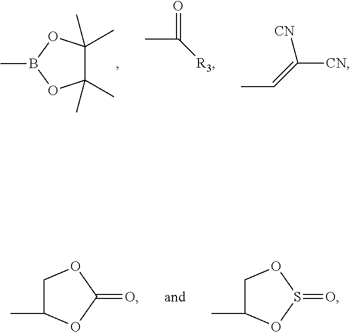
wherein R₃ is selected from C₁₋₆ alkyl.

4. The electrolyte additive composition of claim 1, wherein the cyano-substituted C₄₋₁₀ aromatic compound or the heteroaromatic compound is one of benzene, naphthalene, furan, thiophene, pyrrole, pyrazole, imidazole, oxazole, thiazole, pyridine, benzofuran, benzothiophene, indole, benzimidazole, benzoxazole, benzothiazole, and quinoline.

5. The electrolyte additive composition of claim 1, wherein the compound represented by formula (1) is:

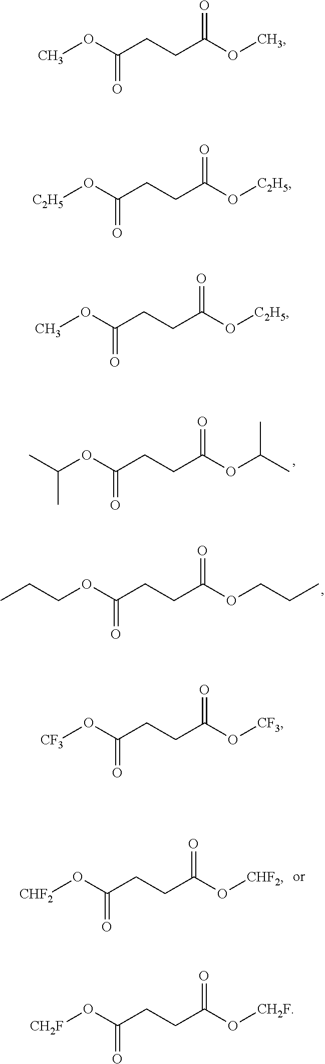

6. The electrolyte additive composition of claim 1, wherein the cyano-substituted C₄₋₁₀ aromatic compound or the heteroaromatic compound is:

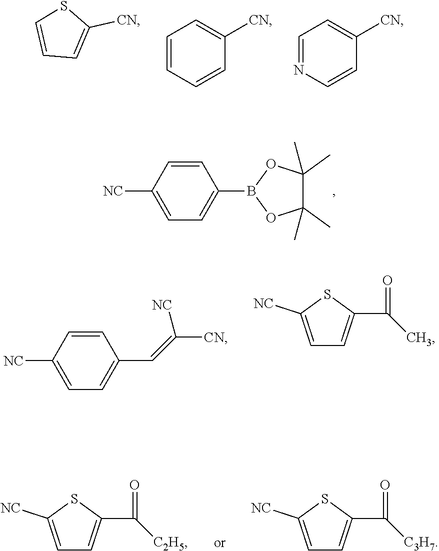

7. The electrolyte additive composition of claim 1, wherein a molar ratio of the compound represented by formula (1) and the cyano-substituted C₄₋₁₀ aromatic compound or the heteroaromatic compound is in a range of 1:2 to 7:2.

8. An electrolyte, comprising an organic solvent, a lithium salt, and the electrolyte additive composition of claim 1.

9. The electrolyte of claim 8, wherein an amount of the compound represented by formula (1) is in a range of about 0.1 parts by weight to about 10 parts by weight, based on 100 parts by weight of a total weight of the organic solvent and the lithium salt.

10. The electrolyte of claim 9, wherein the amount of the compound represented by formula (1) is in the range of about 0.1 parts by weight to about 2.0 parts by weight, based on 100 parts by weight of the total weight of the organic solvent and the lithium salt.

11. The electrolyte of claim 9, wherein the amount of the compound represented by formula (1) is in the range of about 0.2 parts by weight to about 1.0 part by weight, based on 100 parts by weight of the total weight of the organic solvent and the lithium salt.

12. The electrolyte of claim 8, wherein an amount of the cyano-substituted C₄₋₁₀ aromatic compound or the heteroaromatic compound is in a range of about 0.1 parts by weight to about 10 parts by weight, based on 100 parts by weight of a total weight of the organic solvent and the lithium salt.

13. The electrolyte of claim 12, wherein the amount of the cyano-substituted C₄₋₁₀ aromatic compound or the heteroaromatic compound is in the range of about 0.1 parts by weight to about 2.0 parts by weight, based on 100 parts by weight of the total weight of the organic solvent and the lithium salt.

14. The electrolyte of claim 12, wherein the amount of the cyano-substituted C₄₋₁₀ aromatic compound or the heteroaromatic compound is in the range of about 0.2 parts by weight to about 1.0 part by weight, based on 100 parts by weight of the total weight of the organic solvent and the lithium salt.

15. The electrolyte of claim 8, wherein the lithium salt is selected from the group consisting of LiPF₆, LiBF₄, LiAsF₆, LiCF₃SO₃, LiN(SO₂F)₂, LiN(SO₂CF₃)₂, LiC(SO₂CF₃)₃, Li₂SiF₆, or any combination thereof.

16. The electrolyte of claim 8, wherein the organic solvent is selected from the group consisting of propylene carbonate, butylene carbonate, fluoroethylene carbonate, diethyl carbonate, dipropyl carbonate, ethyl methyl carbonate, ethylene carbonate, dimethyl carbonate, or any combination thereof.

17. A lithium-ion secondary battery, comprising:
a positive electrode sheet,
a negative electrode sheet,
a separator, and
the electrolyte of claim 8.

18. A method of preparing an electrolyte for one or both of a lithium-ion secondary battery and a lithium-ion secondary battery comprising, the method comprising utilizing an electrolyte additive composition including:
a cyano-substituted C₄₋₁₀ aromatic compound or a heteroaromatic compound; and
a compound represented by formula (1) 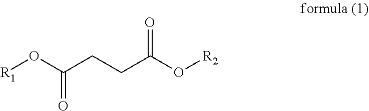
wherein R₁ and R₂ are same or different and selected from unsubstituted or F-substituted C₁₋₆ alkyl.
